(19) United States
(12) Patent Application Publication
(10) Pub. No.: US 2007/0030535 A1
(43) Pub. Date: Feb. 8, 2007

(54) DATA SCAN SYSTEM AND DATA SCAN METHOD USING DDR

(75) Inventors: JIN YONG KANG, SUWON (KR); WON TAE CHOI, Yongin (KR); HAN CHUL JO, Yongin (KR); BYOUNG WON HWANG, Suwon (KR)

Correspondence Address: LOWE HAUPTMAN BERNER, LLP, 1700 DIAGONAL ROAD, SUITE 300, ALEXANDRIA, VA, 22314, US

(73) Assignee: SAMSUNG ELECTRO-MECHANICS CO., LTD., GYUNGGI-DO (KR)

(21) Appl. No.: 11/428,353

(22) Filed: Jun. 30, 2006

(30) Foreign Application Priority Data
Aug. 5, 2005 (KR) 10-2005-0071619

(51) Int. Cl. H04N 1/46

(52) U.S. Cl. 358/505

(57) ABSTRACT

The present invention relates to a data scan system and a data scan method using DDR. The data scan system includes an input section receiving data; first and second DDR memories that stores the data by using a page in which the col address increases horizontally; a DDR controller that stores the data in the first and second DDR memories or reads the stored data from the first and second DDR memories; and an output section that outputs the data read by the DDR controller. When reading the data stored in the first and second DDR memory, the DDR controller simultaneously reads at least two columns of data of the page and stores the simultaneously read data in an output buffer.

### CROSS-REFERENCE TO RELATED APPLICATIONS

The application claims the benefit of Korea Patent Application No. 2005-0071619 filed with the Korea Industrial Property Office on Aug. 5, 2005, the disclosure of which is incorporated herein by reference.

### BACKGROUND OF THE INVENTION

1. Field of the Invention

The present invention relates to a data scan system and data scan method using DDR, and more specifically, to a data scan system and data scan method using DDR, in which one of two data to be stored or output during one clock is stored in an input buffer or output buffer so that high-speed data processing can be performed without repeatedly accessing the same data which is desired to be obtained.

2. Description of the Related Art

In general, the input and output directions of image signals are the same in such a display device as CRT or LCD. However, in a display device using SOM (Spatial Optical Modulator) or GLV (Grating Light Valves), image data is stored horizontally and output vertically. Therefore, the input and output directions of image data differ from each other.

The data scan system and data scan method using DDR according to the present invention are applied to a display device using SOM or GLV. In other words, data are stored horizontally and are displayed vertically at the same time. At this time, in order that data to be input horizontally is output vertically, data corresponding to one frame are stored, and the data should be output while data corresponding to the next frame are input. Therefore, a memory to be used in such a display device should process large-volume data for a short time. That is, the memory should perform high-speed data processing.

In general, as a memory which can store large-volume data, SDRAM (Synchronous Dynamic Random Access Memory), DDR (Double Data Rate)-SDRAM, DDR2-SDRAM, RDRAM (Rambus-DRAM), or the like is used, which is an example of DRAM. SDRAM is used as a data storage means in a display device using GLV.

FIG. 1A is a diagram illustrating DRAM address structure, and FIG. 1B is a diagram illustrating the structure of a page (hereinafter, referred to as ‘the page’) composed of a plurality of cells.

A display screen constitutes one frame 500, and one frame 500 is divided into a plurality of pages 100-1, 100-2, 100-3, . . . , as shown in FIG. 1A. Further, a row address is assigned to each of the pages 100-1, 100-2, . . . , 100-n. In DRAM, the row address mapping activates a desired page among the plurality of pages 100-1, 100-2, . . . , 100-n and allows the corresponding memory to be accessed.

As shown in FIG. 1B, one page 100-1 includes multiple memory cells of which each has a col address. The page 100 of FIG. 1B has 16 col addresses which are numbered from 0 to 15 and which increase horizontally.

On the other hand, when memory cells in the same page are accessed to read and write data, relatively high-speed access is possible. However, when a cell in another page is accessed, a new row address should be designated. That is, relatively high-speed access is possible between the memory cells included in the page 100-1. However, when the cell included in the page 100-2 is accessed from the page 100-1, the corresponding row address is newly designated in the page 100-2. Further, delay due to a page miss occurs in such a process, resulting in reduction in the memory access speed. The number of page misses needs to be reduced to enable the high-speed data processing.

As an approach in which the number of page misses is reduced to enable the high-speed data processing, a technique using a burst mode and a memory bank has been disclosed in US Patent Application No. 2002-0109699. According to the technique disclosed in the above publication, while a burst access is being made to a memory page in a first memory bank, a memory bank in a second memory bank is activated to hide page misses. Similarly, while a burst access is being made to a memory page in the second memory bank, a memory page in the first memory bank is activated.

Besides, another memory bank can be used in addition to the two memory banks. For example, in one implementation using a memory device having four memory banks, a first page is stored in a first memory page of a first memory bank, a second page is stored in a first memory page in a second memory bank, a third page is stored in a first memory page of a third memory bank, a fourth page is stored in a first memory page of a fourth bank, a fifth page is stored in a second memory page of the first memory bank, and so on. This pattern continues throughout the frame so that the entire pages are stored in other memory pages of the first to fourth memory banks.

Further, the first and second memory banks storing the first and second pages having different row addresses are activated at the same time to hide a page miss which is caused when the second page is accessed from the first page. In this technique, by using an aspect that even pages having different row addresses can be activated at the same time in case where they are stored in different memory banks, the delay is reduced to thereby realize high-speed data processing.

However, in the above-described technique using a burst mode and a memory bank, unique characteristics of DDR cannot be exhibited when a display device using SOM or GLV employs DDR memory such as DDR-SDRAM or DDR2-SDRAM (hereinafter, referred to as ‘the DDR memory’) as a storage means.

FIG. 2 is a diagram illustrating a data access method of DDR memory when a burst mode is used.

As shown in FIG. 2, a ‘READ’ command and ‘NOP’ command are alternately issued to the DDR memory during one clock period. However, even though only the ‘READ’ command to QA0 is issued during one clock period, the col address can be increased to read data of QA1 during the same period, because the DDR memory uses a burst mode. As such, data of QA0 and QA1 are read at the same time during one clock period.

However, although the data of QA0 and QA1 can be read at the same time, and when the data of QA0 is accessed to read, the data of QA1 is not necessary, so that it is discarded without being used. Further, when the data of QA1 is desired to be obtained, it is again accessed to read. In other words, in the case where the conventional technique of burst mode and memory bank is applied to DDR as it is, the data of QA0 and QA1 can be read at the same time during one clock time, but the data of QA1 is discarded and should be again accessed to read at the next clock.

As such, in the related art, a characteristic of DDR memory, in which data is accessed twice during one clock, is not used in high-speed data processing, different from SDRAM.

### SUMMARY OF THE INVENTION

An advantage of the present invention is that it provides a data scan system and the method using DDR, in which one of two data to be stored or output during one clock is stored in an input buffer or an output buffer so that high-speed data processing can be performed without repeatedly accessing the same data which is desired to be obtained.

Additional aspects and advantages of the present general inventive concept will be set forth in part in the description which follows and, in part, will be obvious from the description, or may be learned by practice of the general inventive concept.

According to an aspect of the invention, a data scan system using DDR includes an input section receiving data; first and second DDR memories that stores the data by using a page in which the col address increases horizontally; a DDR controller that controls the data to be stored in the first and second DDR memories and to be read from the first and second DDR memories and, when the stored data are read from the first and second DDR memories, controls data corresponding to the same row to be simultaneously read from at least two columns of data of the page; an output buffer that stores the simultaneously read data; and an output section that outputs the data read by the DDR controller and the remaining columns of data stored in the output buffer.

When the data is stored in the first or second DDR memory by the DDR controller, a continuous burst mode is used. When the data is read from the first or second DDR memory by the DDR controller, a burst mode is used.

The DDR controller controls the output section so that the remaining column of data is output after the first column of data is output, and the output buffer includes more than one column.

According to another aspect of the invention, a data scan system using DDR includes an input section receiving data; an input buffer that stores the input data; first and second DDR memories that stores the data by using a page in which the column address increases vertically; a DDR controller that controls the data to be stored in the first or second DDR memory and to be read from the first or second DDR memory and, when the data is stored in the first or second DDR memory, controls data corresponding to the same column to be simultaneously stored from the row of data stored in the input buffer and the row of data which is currently input into the input section; and an output section that outputs the data read by the DDR controller.

When the data is read from the first or second DDR memory by the DDR controller, a continuous burst mode is used. When the data is stored in the first or second DDR memory by the DDR controller, a burst mode is used.

The DDR controller controls the remaining rows of data excluding the last row of data to be stored in the first or second memory before the last row of data is stored, and the input buffer includes more than one row.

Preferably, the arrangement of col addresses of the page differs according to a burst mode which is previously set in the DDR memory. The number of data bits in a memory cell of the first or second DDR memory is equal to or more than that of one pixel data of the data.

While controlling the data to be stored in any one of the first and second DDR memories, the DDR controller controls the data to be read from the other DDR memory. The data scan system using DDR is applied to a display device in which the input and output directions of the data are different from each other.

According to a further aspect of the invention, a data scan method using DDR includes receiving data; storing the data in a first or second DDR memory by using a page in which the col address increases horizontally; in the cases of reading the data stored in the first or second DDR memory by using the page, simultaneously reading data corresponding to the same row from at least two columns of data of the page of the data stored in the first or second DDR memory; storing the simultaneously read data in an output buffer; and outputting the data.

In storing the data in the first or second DDR memory, a continuous burst mode is used. In reading the data stored in the first or second DDR memory, a burst mode is used. In addition, the remaining column of data is output after the first column of data is output.

According to a still further aspect of the invention, a data scan method using DDR includes receiving data; storing the received data in an input buffer; in the case of storing the data in a first or second DDR memory by using a page in which the col address increases vertically, simultaneously storing data corresponding to the same column in the row of data stored in the input buffer and the row of data which is currently input; reading the data stored in the first or second DDR memory by using the page; and outputting the data.

In reading the data stored in the first or second DDR memory, a continuous burst mode is used. In storing the data in the first or second DDR memory, a burst mode is used. Further, the remaining rows of data are stored in the first or second DDR memory before the last row of data is stored.

Preferably, the arrangement of col addresses of the page differs according to a burst mode which is previously set in the DDR memory. The number of data bits in a memory cell of the first or second DDR memory is equal to or more than the number of bits of one pixel data of the data. Further, storing the data in the first or second DDR memory and reading the data stored in the first or second DDR memory are performed at the same time.

The data scan method using DDR is applied to a display device in which the input and output directions of the data are different from each other.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1A is a diagram illustrating a DRAM address structure;

FIG. 1B is a diagram illustrating the structure of a page composed of many cells;

FIG. 2 is a diagram illustrating a data access method of DDR in the case where a burst mode is used;

FIG. 3 is a block diagram illustrating a scan system according to the present invention;

FIG. 4 is a diagram illustrating a page which is an embodiment of the invention and in which the col address increases horizontally;

FIG. 5 is a diagram for explaining that data having 1920×1080 resolution is read by using the page shown in FIG. 4;

FIG. 6 is a block diagram specifically showing a scan system according to an embodiment of the invention;

FIG. 7 is a diagram illustrating a page which is another embodiment of the invention and in which the col address increases vertically;

FIG. 8 is a diagram for explaining that data having 1920×1080 resolution is read by using the page shown in FIG. 6; and

FIG. 9 is a block diagram specifically showing a scan system according to another embodiment of the invention.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

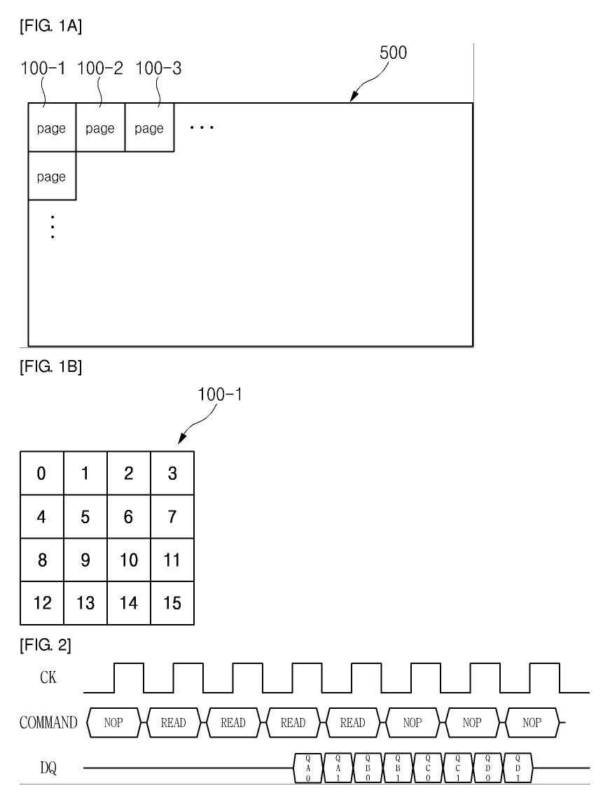

Hereinafter preferred embodiments of the present invention will now be described in detail with reference to the accompanying drawings. Among the reference numerals explained in FIGS. 1 and 2 according to the related art, like reference numerals are applied to the same components as those of the present invention.

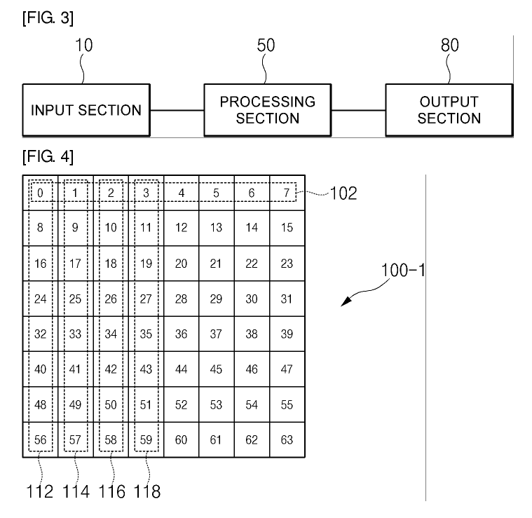

FIG. 3 is a block diagram illustrating a data scan system using DDR which is applied to a display device in which the input and output directions of data are different from each other.

As shown in FIG. 3, the scan system according to the invention includes an input section 10, a processing section 50, and an output section 80.

The input section 10 provides a data frame composed of pixels to the processing section 50. The processing section 50 stores (corresponding to ‘write’) the frame input from the input section 10 by using pages, re-reads (corresponding to ‘read’) the stored data, and provides it to the output section 80. In other words, the processing section 50 serves to store data and re-read the stored data, and the input and output directions of data are different from each other when the data is stored and read.

Hereinafter, for the address arrangement of pages used by the processing section 50, embodiments of the scan system using DDR according to the invention will be described in a case where a col address increases horizontally and in a case where a col address increase vertically, respectively.

### First Embodiment

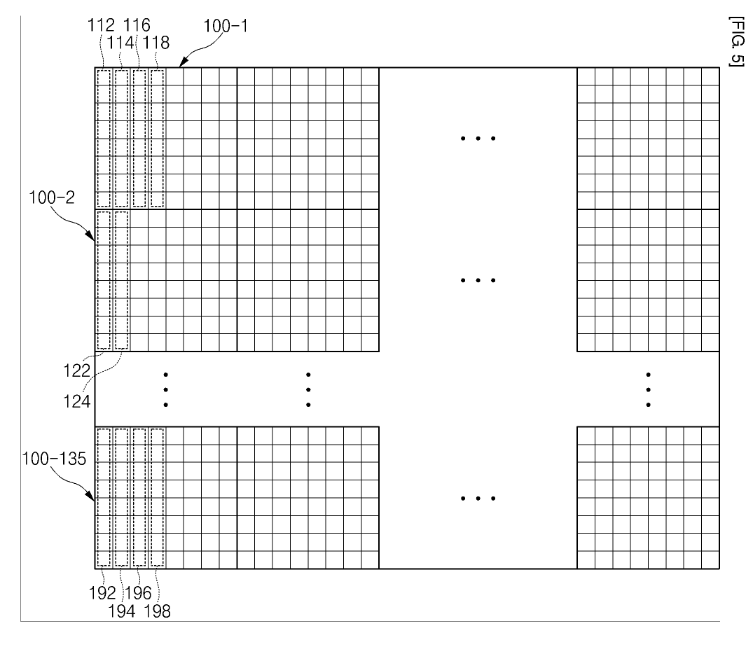

FIG. 4 is a diagram illustrating a page used by the processing section 50, showing a case where the col address increases horizontally.

As shown in FIG. 4, the page 100-1 has an 8×8 structure, in which the col address increases horizontally by one. Since the page 100-1 shown in FIG. 4 is arranged so that the col address increases horizontally, a continuous burst mode is used when data to be input horizontally is stored.

When the burst mode is used, data to be input can be sequentially stored in a memory cell in which the col address increases within one page 100-1, without any separate instruction from a user. When a burst mode whose burst length is 8 is used in the page 100-1 shown in FIG. 4, data to be input into a memory cell can be stored in an order of col addresses 0, 1, 2, 3, 4, 5, 6, and, 7 without any separate instruction from a user.

When data are completely stored in a first row 102 of the first page 100-1 shown in FIG. 4, another page 100-2 having a different row address is accessed so that data are stored in a first row of the page 100-2. In such a manner, the data of a first frame are sequentially stored in first rows of all the pages 100-n by using a burst mode. Further, when data are completely stored in the first rows of all the pages 100-n, data are stored in the second rows of all the pages 100-n. As such, the data of the first frame are stored using the pages 100-n.

After the data of the first frame are stored, the data of a second frame are stored in the same way. While the data of the second frame are stored, the data of the first frame which have been already stored are output vertically. That is, the data are output in an order of col address 0, 8, 16, 24, 32, 40, 48, and 56.

When a burst mode whose burst length is 2 is used to output data, the data of the col address 0 and the data of the col address 1 are read at the same time during one clock, without any separate instruction from a user. Referring to the structure of the page of FIG. 4, the data of the col addresses 0 and 1, 8 and 9, 16 and 17, 24 and 25, 32 and 33, 40 and 41, 48 and 49, and 56 and 57 are sequentially read. That is, while the data of a first column 112 are read, the data of a second column 114 are read at the same time.

In the present embodiment, the data of the second column 114 are stored in a buffer. Accordingly, the data of the second column 114, which are read at the same time while the data of the first column 112 are read, are not discarded but stored, which makes it possible to omit the process of re-reading the data of the second column 114. Among the data of the first and second columns 112 and 114 which are read at the same time, the data of the first column 112 are output, and the data of the second column 114 are then output from the buffer.

While the data of the first and second columns 112 and 114 are output, the data of third and fourth columns 116 and 118 are read in the same manner. Further, the data of the third column 116 are output, and the data of the fourth column 118 are stored in a buffer. Such a process is repeated until reading data up to the last column vertically is completed.

FIG. 5 is a diagram for explaining that data having 1920×1080 resolution is read using the page 100 of the structure shown in FIG. 4.

As shown in FIG. 5, one frame has a plurality of pages. In order to process data having 1920×1080 resolution, 1920/8 pages and 1080/8 pages, i.e. 240 pages and 135 pages are required horizontally and vertically, respectively, because one page has an 8×8 structure.

The sequence where memory cells stored in DDR memory are read is described in the pages shown in FIG. 5. Data corresponding to first and second columns 112 and 114 of the first page 100-1 are sequentially read. If the data of the first and second columns 112 and 114 of the first page 100-1 are completely read, the data of first and second columns 122 and 124 of a second page 100-2 are read, and the data of first and second columns of a third page are then read. In such a manner, after the data of first and second columns 192 and 194 of a 135th page 100-135 are completely read, the data of the third and fourth columns 116 and 118 of the first page 100-1 are then read. Similarly, data up to third and fourth columns 196 and 198 of the 135th page 100-135 are read. With reference to FIG. 5, the sequence can be completely explained, where an image having 1920×1080 resolution is read using the page shown in FIG. 4.

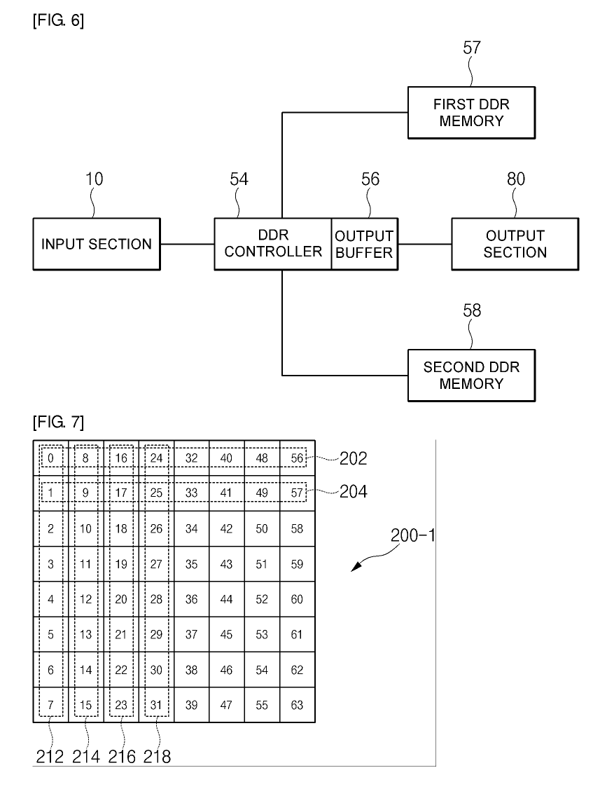

FIG. 6 is a block diagram specifically showing the scan system according to an embodiment of the invention.

As shown in FIG. 6, the scan system according to the invention includes the input section 10, a DDR controller 54, an output buffer 56, a first DDR memory 57 and a second DDR memory 58.

The input section 10 receives data. The received data is sent to the DDR controller 54 which is connected to the input section 10. In addition, the DDR controller 54 is connected to the first and second DDR memories 57 and 58 so as to send the input data to the first DDR memory 57 or the second DDR memory 58.

At this time, while data are stored in one of the first and second DDR memories 57 and 58, which are respectively independent memory means, data are read from the other DDR memory. In other words, during the same period of clock, data can be stored in the first DDR memory, and data can be read from the second DDR memory.

More specifically, the first frame of the input data is stored in the first DDR memory 57. Then, the second frame of the data is stored in the second DDR memory 58. While the second frame of the data is stored in the second DDR memory 58, the first frame stored in the first DDR memory 57 is read from the first DDR memory 57. As such, at the same time when the second frame is stored, the first frame is read. In such a manner, the first and second DDR memories 57 and 58 alternately repeat write/read operations for each frame.

In a case where the frame of data is processed by using the page having the structure of FIG. 4, first, the DDR controller 54 stores a first frame into the first DDR memory 57. At this time, in the process where the first frame is stored in the first DDR memory 57, the pages 100-n shown in FIG. 4 are arranged so that the col address increases vertically. Therefore, by using a burst mode, data to be input are stored in memory cells in an order where the col address increases. Through such a method, the first frame can be all stored using a burst mode.

When the first frame is all stored in the first DDR memory 57, the DDR controller 54 stores a second frame of data into the second DDR memory 58. Further, at this time, the first frame stored in the first DDR memory 57 is output vertically. The DDR controller 54 simultaneously reads the data stored in the first and second columns 112 and 114 of the first frame from the first DDR memory 57 so as to provide the data of the first column 112 to the output section 80 and to store the data of the second column 114 in the output buffer 56. Accordingly, re-reading the data of the second column 114 from the first DDR memory 57 can be omitted, and the data of the third column 116 can be read.

In other words, while the second frame is stored in the second DDR memory 58, the data of the first and second columns 112 and 114 of the first DDR memory 57 are read, so that the data of the first column 112 are output and the data of the second column 114 are stored in the output buffer 56. Further, when the data of the first column 112 are completely output, the DDR controller 54 outputs the data of the second column 114 from the output buffer 56. In such a manner, the data of the entire columns of the first frame are output.

### Second Embodiment

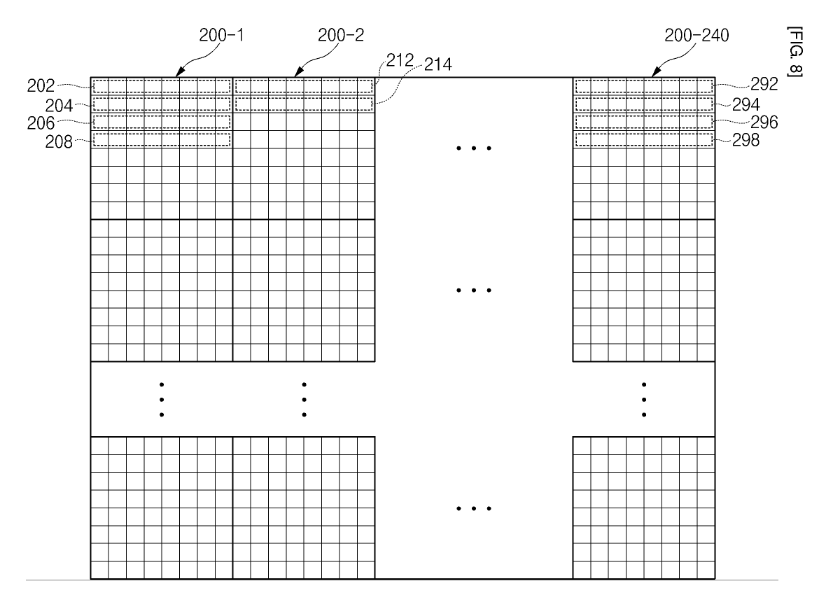

FIG. 7 is a diagram illustrating a page used by the processing section 50, which is another embodiment of the present invention. Different from the above-described first embodiment, a second embodiment employs a page in which the col address increase vertically.

As shown in FIG. 7, a page 200-1 has 8×8 structure, in which the col address increases vertically. Since the page 200-1 shown in FIG. 7 is arranged so that the col address increases vertically, a horizontally continuous burst mode cannot be used, but a vertically continuous burst mode can be used.

Since data is input horizontally, data is read horizontally. That is, a first row of data is input. The read data of the first row is stored in a buffer. Then, when a second row of data is input, the data of the first row is stored in the page 200-1 having the structure of FIG. 7. At this time, if a burst mode whose burst length is 2 is used, data is stored in a memory cell of the col address 0 and the col address automatically increases so that data can be simultaneously stored in a memory cell of the col address 1, without any separate instruction from a user.

Accordingly, the data of the first row and the data of the second row are simultaneously stored in the first and second rows 202 and 204 of the page 200-1. In other words, data are simultaneously stored in memory cells of DDR memory of which the col addresses are 0 and 1, 8 and 9, 16 and 17, 24 and 25, 32 and 33, 40 and 41, 49 and 50, and 56 and 57. In such a manner, data are stored continuously in two memory cells of the same column, so that all data of one frame are stored.

FIG. 8 is a diagram for explaining that data having 1920×1080 resolution is written using the page having the structure shown in FIG. 7.

As shown in FIG. 8, one frame has a plurality of pages. In order to process data having 1920×1080 resolution, 1920/8 pages and 1080/8 pages, i.e. 240 pages and 135 pages are required horizontally and vertically, respectively, because one page has an 8×8 structure.

The sequence where data is stored in and read from memory cells of DDR memory is described in the pages shown in FIG. 8. Data corresponding to first and second rows 202 and 204 of the first page 200-1 are sequentially stored. When the data are completely stored in the first and second rows 202 and 204 of the first page 200-1, data are stored in first and second rows 212 and 214 of a second page 200-2, and data are stored in first and second rows of a third page. Further, the data stored in the DDR memory in the above sequence are read.

When data to first and second rows 292 and 294 of a 240th page 200-240 are completely read in such a manner, the data of third and fourth rows 206 and 208 of the first page 200-1 are read. Similarly, data up to third and fourth rows 296 and 298 of the 240th page are read. With reference to FIG. 8, the sequence can be explained completely, where an image having 1920×1080 resolution is read using the page shown in FIG. 4.

When one frame of data is completely stored in DDR memory, the next frame is then stored in DDR memory. At this time, the data of the previous frame is output. The data is output vertically, and the page shown in FIG. 7 is arranged so that the col address increases vertically. Therefore, a vertically continuous burst mode can be used.

Since the page 200-1 shown in FIG. 7 has an 8×8 structure, the col address increases in an order of 0, 1, 2, 3, 4, 5, 6, and 7 without any separate instruction of a user, while the data of the memory cells are output. That is, a burst mode whose burst length is 8 can be used.

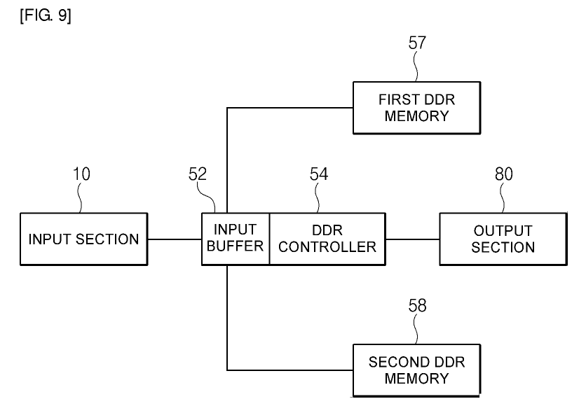

FIG. 9 is a block diagram in which the scan system of FIG. 3 is more specifically embodied, illustrating a scan system according to a further embodiment of the invention.

The scan system shown in FIG. 9 includes an input section 10, an input buffer 52, a DDR controller 54, a first DDR memory 57, a second DDR memory 58, and an output section 80.

The input section 10 receives data, and the DDR controller 52 is connected to the first and second DDR memories 57 and 58. While data is stored in one of the first and second DDR memories 57 and 58 which are respectively independent memory means, data is read (corresponding to ‘read’) from the other DDR memory. In other words, at the same time when the second frame is stored, the first frame of data is read. In such a manner, the first and second DDR memories 57 and 58 alternately repeat write/read operations for each frame.

The DDR controller 54 of the scan system of FIG. 9 vertically reads the first page of the first frame of input data, while storing data in the DDR memory. When a first row of data is input, the first row of input data is stored in the input buffer 52. Then, when a second row of data is input, the first row of data stored in the input buffer 52 and the second row of data are stored into the first DDR memory 57 by using a burst mode. In other words, data are simultaneously stored in the first page of the first DDR memory 57 at the col addresses of 0 and 1, 8 and 9, 16 and 17, 24 and 25, 32 and 33, 40 and 41, 49 and 50, and 56 and 57, respectively. In such a manner, data are stored continuously in two memory cells of the same column, so that all data of one frame are stored.

Then, the second frame of data is stored, and the process where the second frame is stored is the same as the first frame is stored. In other words, the data of the second frame are simultaneously stored in first and second columns of memory cells of one page of the second DDR memory 58. Further, while the second frame of data is stored in the second DDR memory 58, the first frame stored in the first DDR memory 57 is read from the first DDR memory 57.

In other words, at the same clock period when the second frame of data is stored, the first frame of data is output. When the DDR controller 54 outputs data from the first DDR memory, the data is output vertically. Since the page shown in FIG. 7 is arranged so that the col address increases vertically, a vertically continuous burst mode can be used. That is, when data is output, a vertically continuous burst mode is used, so that data corresponding to the col addresses of 0, 1, 2, 3, 4, 5, 6, and 7 are continuously output without any separate instruction of a user.

In the above-described embodiments, such a case has been described, where the page of 8×8 structure having 64 different col addresses is used. In order to use the input buffer 52 or the output buffer 56, the number of data bits of one memory cell should be equal to or more than the number of bits of one pixel data (24 bits in the case of 8-bit RGB). For this, several memory devices having a small number of bits can be configured in parallel so as to process one pixel data.

In the present invention, the size of the input buffer 52 or the output buffer 54 is enlarged, so that many rows of data or many columns of data can be stored and then written, and vice versa. For example, in case where a burst mode is used horizontally, the burst mode can be set to 4 when data is read from a memory. Then, after data of 0 to 3 are read during two clocks, the data are stored. Further, after data of 8 to 11 are read, the data are stored to read the next row of data. In addition, a burst mode can be used vertically to write data in the same manner.

In the present invention, the input buffer 52 or the output buffer 54 can be composed of one row or one column so as to store data. For example, when a burst mode is used horizontally, data of 0 to 1 are read from a memory during one clock. Then, the data of 0 is immediately output and the data of 1 is stored. After one column of data is completely output, the stored column of data can be output. In addition, a burst mode is used vertically to write data in the same way.

In addition, the col addresses of the pages shown in FIGS. 4 and 7 do not need to be continuously arranged. However, in accordance with the setting of DDR memory, they can be arranged according to an available sequence of burst mode. That is, in the case of DDR memory where a burst mode is set so that data can be automatically accessed in an order of 2-3-0-1, the col addresses can be arranged in an order of 2-3-0-1, unlike a case where the col address increase in an order of 0-1-2-3 as in FIGS. 4 and 7.

As described above, according to the data scan system and data scan method using DDR, one of two data which are stored or output during one clock is stored in the input buffer or the output buffer. Therefore, high-speed data processing can be performed without repeatedly accessing the same data which is desired to be obtained.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A data scan system using DDR comprising:
an input section receiving data;
first and second DDR memories that stores the data by using a page in which the col address increases horizontally;
a DDR controller that controls the data to be stored in the first and second DDR memories and to be read from the first and second DDR memories and, when the stored data are read from the first and second DDR memories, controls data corresponding to the same row to be simultaneously read from more than two columns of data of the page;
an output buffer that stores the simultaneously read data; and
an output section that outputs the data read by the DDR controller and the remaining columns of data stored in the output buffer.

2. The data scan system using DDR according to claim 1,
wherein, when the data is stored in the first or second DDR memory by the DDR controller, a continuous burst mode is used.

3. The data scan system using DDR according to claim 1,
wherein, when the data is read from the first or second DDR memory by the DDR controller, a burst mode is used.

4. The data scan system using DDR according to claim 1,
wherein the DDR controller controls the output section so that the remaining column of data is output after the first column of data is output.

5. The data scan system using DDR according to claim 1,
wherein the output buffer includes more than one column.

6. A data scan system using DDR comprising:
an input section receiving data;
an input buffer that stores the received data;
first and second DDR memories that stores the data by using a page in which the col address increases vertically;
a DDR controller that controls the data to be stored in the first or second DDR memory and to be read from the first or second DDR memory and, when the data is stored in the first or second DDR memory, controls data corresponding to the same column to be simultaneously stored, in the row of data stored in the input buffer and the row of data which is currently input into the input section; and
an output section that outputs the data read by the DDR controller;

7. The data scan system using DDR according to claim 6,
wherein, when the data is read from the first or second DDR memory by the DDR controller, a continuous burst mode is used.

8. The data scan system using DDR according to claim 6,
wherein, when the data is stored in the first or second DDR memory by the DDR controller, a burst mode is used.

9. The data scan system using DDR according to claim 6,
wherein the DDR controller controls the remaining rows of data excluding the last row of data to be stored in the first or second memory before the last row of data is stored.

10. The data scan system using DDR according to claim 6,
wherein the input buffer includes more than one row.

11. The data scan system using DDR according to claim 1,
wherein the arrangement of col addresses of the page differs in accordance with a burst mode which is previously set in the DDR memory.

12. The data scan system using DDR according to claim 1,
wherein the number of data bits in a memory cell of the first or second DDR memory is more than that of one pixel data of the data.

13. The data scan system using DDR according to claim 1,
wherein, while controlling the data to be stored in any one of the first and second DDR memories, the DDR controller controls the data to be read from the other DDR memory.

14. The data scan system using DDR according to claim 1,
wherein the data scan system using DDR is applied to a display device in which the input and output directions of the data are different from each other.

15. A data scan method using DDR comprising:
receiving data;
storing the data in a first or second DDR memory by using a page in which the col address increases horizontally;
in the case of reading the data stored in the first or second DDR memory by using the page, simultaneously reading data corresponding to the same row from more than two columns of data of the page of the data stored in the first or second DDR memory;
storing the simultaneously read data in an output buffer; and
outputting the data.

16. The data scan method using DDR according to claim 15,
wherein, in storing the data in the first or second DDR memory, a continuous burst mode is used.

17. The data scan method using DDR according to claim 15,
wherein, in reading the data stored in the first or second DDR memory, a burst mode is used.

18. The data scan method using DDR according to claim 15,
wherein the remaining column of data is output after the first column of data is output.

19. A data scan method using DDR comprising:
receiving data;
storing the received data in an input buffer;
in the case of storing the data in a first or second DDR memory by using a page in which the column address increases vertically, simultaneously storing data corresponding to the same column in the row of data stored in the input buffer and the row of data which is currently input;
reading the data stored in the first or second DDR memory by using the page; and
outputting the data.

20. The data scan method using DDR according to claim 19,
wherein, in reading the data stored in the first or second DDR memory, a continuous burst mode is used.

21. The data scan method using DDR according to claim 19,
wherein, in storing the data in the first or second DDR memory, a burst mode is used.

22. The data scan method using DDR according to claim 19,
wherein the remaining rows of data are stored in the first or second DDR memory before the last row of data is stored.

23. The data scan method using DDR according to claim 19,
wherein the arrangement of col addresses of the page differs in accordance with a burst mode which is previously set in the DDR memory.

24. The data scan method using DDR according to claim 15,
wherein the number of data bits in a memory cell of the first or second DDR memory is equal to or more than that of one pixel data of the data.

25. The data scan method using DDR according to claim 15,
wherein storing the data in the first or second DDR memory and reading the data stored in the first or second DDR memory are performed at the same time.

26. The data scan method using DDR according to claim 16,
wherein the data scan method using DDR is applied to a display device in which the input and output directions of the data are different from each other.
